(19) United States
(12) Patent Application Publication
(10) Pub. No.: US 2008/0223310 A1
(43) Pub. Date: Sep. 18, 2008

(54) ANIMAL COAT WITH INTEGRATED HARNESS

(75) Inventors: Gary L. Remick, Surfside Beach, SC (US); Michele L. Ochs, Surfside Beach, SC (US)

Correspondence Address: LARSON AND LARSON, 11199 69TH STREET NORTH, LARGO, FL, 33773, US

(73) Assignee: DOGGIE DESIGNS, INC., Surfside Beach, SC (US)

(21) Appl. No.: 11/686,182

(22) Filed: Mar. 14, 2007

(51) Int. Cl. A01K 27/00

(52) U.S. Cl. 119/792; 119/850

(57) ABSTRACT

An application for an animal coat with integrated harness includes a cloth coat section with two leg openings in its bottom surface for accepting the animal's front legs. A longitudinal spine member is affixed to an inside upper location of the cloth coat section and a neck encircling strap is affixed to the longitudinal spine member at a location near its front portion. A chest encircling strap is affixed to the longitudinal spine member rearward of the two leg openings.

### FIELD OF THE INVENTION

This invention relates to the field of clothing and more particularly to a coat for an animal such as a dog having an integrated leash attachment loop.

### BACKGROUND OF THE INVENTION

Many animals, in particular dogs, especially smaller dogs and shorthaired dogs, often suffer from cold weather. Many attempts have been made to keep these animals warm during cold weather, especially while walking with their master.

Several animal coats have been marketed for the purpose of keeping the animal warm. In the past, many pet owners used a collar and leash system to keep their pet at bay while walking. The pet usually wears such a collar around their neck. Lately, out of concern for the pet's comfort, more and more pet owners are using a harness that contains the body of the pet with several straps and attaches to a leash for walking the pet. Harnesses improve the comfort for the pet by reducing strain to their neck. Unfortunately, it is difficult to outfit a pet with a harness, and then add a coat, and then find the leash attach loop to attach a leash.

U.S. Pat. No. 7,121,231 to Benefiel describes a dog coat made from five two-ply sheets of material for manufacturing ease and cost reduction. The coat described has no leash attachment ring requiring the pet to be leashed by the collar or an auxiliary harness worn outside or inside the described coat. The drawbacks of leashing by a collar are known. Using a separate harness provides difficulty in dressing the animal. Furthermore, if the harness is donned first, it may be difficult to access the leash attachment ring attached to the harness. Although the dog coat described does not have a leash attachment ring, simply adding one to the described invention would not work because the described dog coat has no reinforced integrated straps and, therefore, would easily tear under the force of a struggling dog.

U.S. Pat. No. 5,941,199 to Tamura describes a cat jacket for walking cats. This jacket has a leash attachment ring, but since some dogs can exert more force than the typical cat, the described leash attachment ring would easily tear due to a lack of structural straps (e.g., a harness). Furthermore, the described coat fails to cover much of the animal, falling short for use in cold weather.

U.S. Pat. No. 2,850,860 to Torell, et al., describes an animal coat having a single strap for holding the coat on the animal. The described coat does not have a leash attachment ring, nor does it provide the structural strength of a harness and therefore is not useful for walking a pet such as a dog.

U.S. Pat. No. 1,595,834 to Griffiths describes an animal coat with a single structural strap and a leash attachment ring. Unfortunately, the single structural strap does not function well as a harness, placing most of the stress on one area of the animal's chest.

What is needed is an animal coat that is integrated with a harness system the keeps the animal warm while comfortably restraining the animal during walks.

### SUMMARY OF THE INVENTION

In one embodiment, an animal coat with integrated harness is disclosed including a cloth coat section with two leg openings in its bottom surface for accepting the animal's front legs. A longitudinal spine member is affixed to an inside upper location of the cloth coat section and a neck encircling strap is affixed to the longitudinal spine member at a location near its front portion. A chest encircling strap is affixed to the longitudinal spine member rearward of the two leg openings.

In another embodiment, an animal coat with integrated harness is disclosed including a cloth coat section with opening for accepting the animal's front legs and a longitudinal strap for support affixed to an inside upper location of the cloth coat section. A strap for containing the animal's neck affixed to the longitudinal strap at a location near a front portion and a strap for containing animal's chest is affixed to the longitudinal strap at a location rearward of the openings for the animal's front legs.

In another embodiment, an animal coat with integrated harness is disclosed including a cloth coat section with two leg openings in its bottom surface for accepting the animal's front legs. A longitudinal spine member is affixed to an inside upper location of the cloth coat section and a neck encircling strap is affixed to the longitudinal spine member at a location near a front portion of the longitudinal spine member with neck fasteners affixed at its ends. A chest encircling strap is affixed to the longitudinal spine member at a location rearward of the two leg openings with chest fasteners affixed at its ends. A leash attachment ring is affixed to the longitudinal spine member near where the longitudinal spine member is affixed to the chest encircling strap.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an animal coat of the present invention being used to walk a dog.

FIG. 2 illustrates a schematic top view of an animal coat of the present invention.

FIG. 3 illustrates a schematic top view of an animal coat of the present invention scaled for smaller animals.

FIG. 4 illustrates a schematic bottom view of an animal coat of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

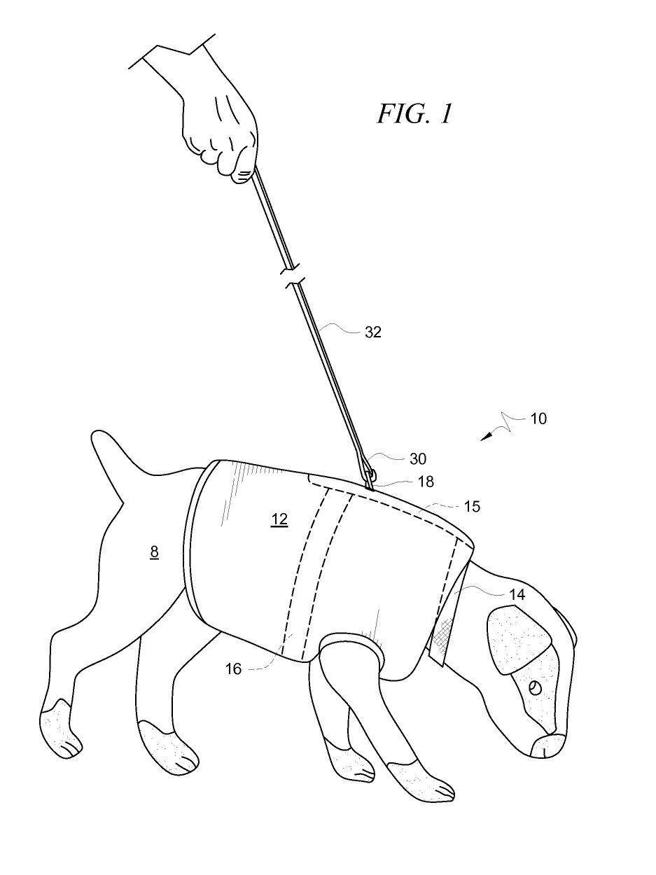

Referring to FIG. 1, a schematic view of an animal coat of the present invention being used to walk a dog will be described. The animal coat 10 has two functions: it keeps the animal 8 warm and it restrains the animal 8 during exercise (walking). To function well at providing warmth, the animal coat 10 has a cloth section 12 that covers the animal 8, thereby keeping the animal warm. To restrain the animal 8, the coat 12 has an integrated harness comprising a longitudinal spine member 15 and two encircling members 14/16. A neck encircling member 14 encircles the animal's neck while a chest encircling member 16 encircles the animal's chest behind its front legs, thereby preventing the animal from escaping from the coat 8 while providing ample comfort to the animal while exercising/walking. A leash attachment ring 18 or D-ring 18 is attached to the longitudinal spine member 15 at a point near where the longitudinal spine member 15 interfaces with the chest encircling member 16, thereby focusing the force of the animal 8 on the animal's 8 chest area instead of its neck area. The leash attachment ring 18 allows for a leash hook 30 to be removably attached to/from the animal coat 10. The leash hook 30 is affixed to the end of a leash 32.

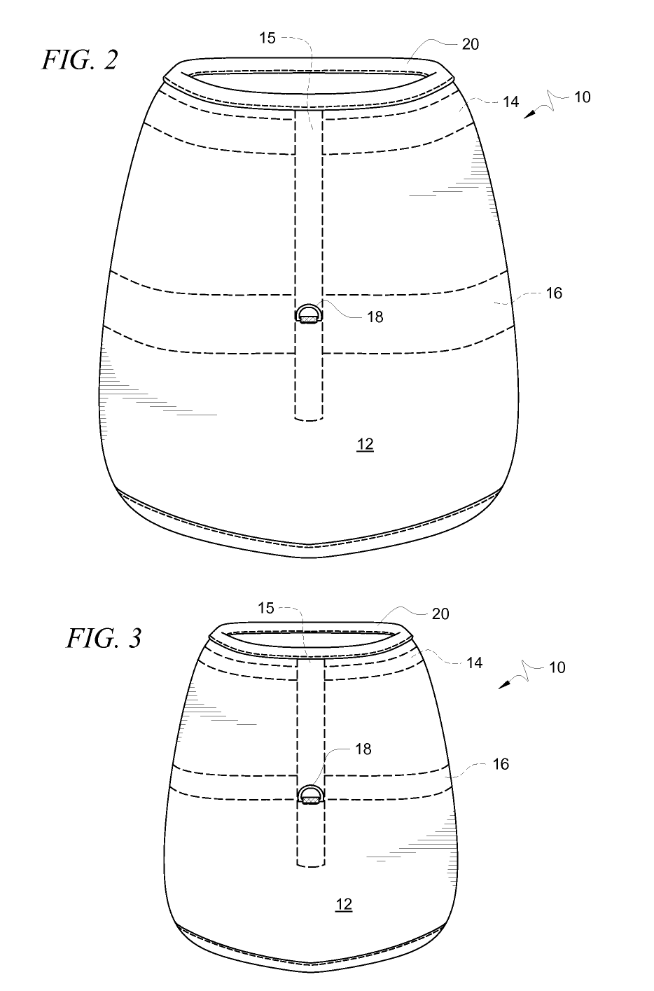

Referring to FIG. 2, a schematic top view of an animal coat of the present invention will be described. The coat 10 has a cloth material section 12 that encircles the animal's 8 chest and abdominal area. An integrated harness includes a longitudinal strap 15 that is affixed to the inside of the coat 10 by stitching or other means. A neck encircling strap 14 encircles the animal's 8 neck (when the coat 10 is in use) and is affixed to the longitudinal spine strap 15 by stitching or other means. The neck encircling strap 14 encircles the animal's neck, keeping the coat 10 from shifting rearwards. A chest encircling strap 16 is affixed to the longitudinal spine strap 15 by stitching or other means. The chest encircling strap 16 encircles the animal's 8 chest between the animal's 8 front legs and hind legs. In some embodiments, the neck portion 20 of the coat 10 is stitched to prevent fraying. A leash attachment ring 18 or D-ring 18 is affixed to the coat 10 and the longitudinal strap 15 by stitching or other means. Although the leash attachment ring 18 is attachable at any location along the longitudinal strap 15, it is preferred that the leash attachment ring 18 be attached at a location near where the longitudinal spine strap 15 crosses the chest encircling strap 16, thereby concentrating the force of the pull of the animal 8 on the animal's 8 chest, rather than on the animal's 8 neck.

Referring to FIG. 3, a schematic top view of an animal coat of the present invention scaled for smaller animals will be described. As with the previous coat 10, a harness is integrated into the coat 10 and includes a longitudinal spine strap 15 that is affixed to the inside of the coat 10 by stitching or other means. A neck encircling strap 14 encircles the animal's 8 neck (when the coat 10 is in use) and is affixed to the longitudinal spine strap 15 by stitching or other means. A chest encircling strap 16 is affixed to the longitudinal spine strap 15 by stitching or other means. The chest encircling strap 16 encircles the animal's 8 chest between the animal's 8 front legs and hind legs. In some embodiments, the neck portion 20 of the coat 10 is stitched to prevent fraying. A leash attachment ring 18 or D-ring 18 is affixed to the coat 10 and the longitudinal spine strap 15 by stitching or other means. Although the leash attachment ring 18 is attachable at any location along the longitudinal strap 15, it is preferred that the leash attachment ring 18 be attached at a location near where the longitudinal spine strap 15 crosses the chest encircling strap 16, thereby concentrating the force of the pull of the animal 8 on the animal's 8 chest, rather than on the animal's 8 neck.

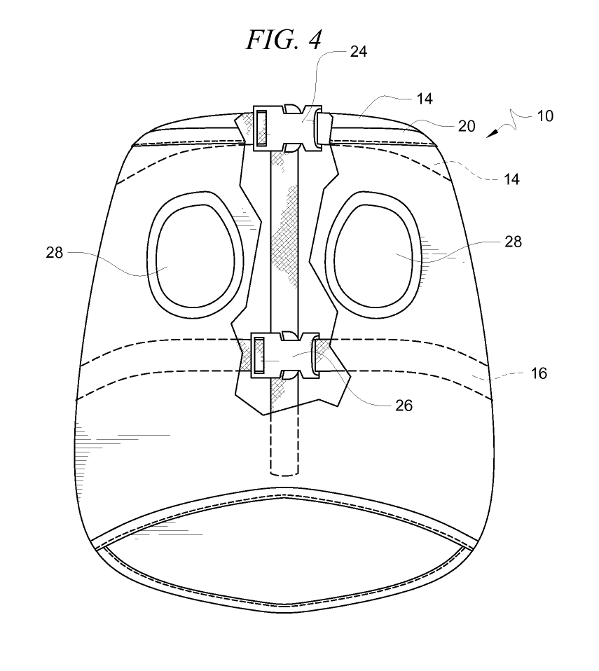

Referring to FIG. 4, a schematic bottom view of an animal coat of the present invention will be described. Two holes 28 are provided for the animal's 8 legs to pass through the cloth section 12. The neck encircling strap 14 connects to itself with a fastener 24, thereby forming a loop through which the animal's neck is contained when the fastener 24 is engaged. Note that the neck encircling strap 14 is only affixed to the coat 10 where it interfaces with the longitudinal spine strap 15 to prevent the cloth section 12 from bunching up while in use.

The chest encircling strap 16 connects to itself with a fastener 26, thereby forming a loop through which the animal's chest is contained when the fastener 26 is engaged. Note that the chest encircling strap 16 is only affixed to the coat 10 where it interfaces with the longitudinal spine strap 15 to prevent the cloth section 12 from bunching up while in use.

The fasteners 24/26 are preferably snap fasteners. In alternate embodiments, the fasteners are any known fastener including hook and loop fasteners, buckles, ets.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An animal coat with integrated harness comprising:
a cloth coat section;
two leg openings in a bottom surface of the cloth coat section for accepting an animal's front legs;
a longitudinal spine member affixed to an inside upper location of the cloth coat section;
a neck encircling strap affixed to the longitudinal spine member at a location near a front portion of the longitudinal spine member; and
a chest encircling strap affixed to the longitudinal spine member at a location rearward of the two leg openings.

2. The animal coat with integrated harness of claim 1, further comprising a neck fastener affixed at ends of the neck encircling strap and a chest fastener affixed at ends of the chest encircling strap.

3. The animal coat with integrated harness of claim 2, wherein the neck fastener and the chest fastener are snap fasteners.

4. The animal coat with integrated harness of claim 1, wherein the longitudinal spine member is affixed to the cloth coat section by stitching.

5. The animal coat with integrated harness of claim 1, wherein the neck encircling strap is affixed to the longitudinal spine member by stitching.

6. The animal coat with integrated harness of claim 1, wherein the chest encircling strap is affixed to the longitudinal spine member by stitching.

7. The animal coat with integrated harness of claim 1, further comprising a leash attachment ring affixed to the longitudinal spine member near where the longitudinal spine member is affixed to the chest encircling strap.

8. An animal coat with integrated harness comprising:
a cloth coat section;
a means for accepting an animal's front legs;
a longitudinal means for supporting affixed to an inside upper location of the cloth coat section;
a means for containing a neck of the animal affixed to the longitudinal means for supporting at a location near a front portion of the longitudinal means for supporting; and
a means for containing a chest of the animal affixed to the longitudinal means for supporting at a location rearward of the means for accepting the animal's front legs.

9. The animal coat with integrated harness of claim 8, further comprising a neck means for fastening affixed at ends of the means for containing the neck of the animal and a chest means for fastening affixed at ends of the means for containing the chest of the animal.

10. The animal coat with integrated harness of claim 9, wherein the neck means for fastening and the chest means for fastening are snap fasteners.

11. The animal coat with integrated harness of claim 8, wherein the longitudinal means for supporting is affixed to the cloth coat section by stitching.

12. The animal coat with integrated harness of claim 8, wherein the means for containing the neck of the animal is affixed to the longitudinal spine member by stitching.

13. The animal coat with integrated harness of claim 8, wherein the means for containing the chest of the animal is affixed to the longitudinal spine member by stitching.

14. The animal coat with integrated harness of claim 8, further comprising a means for attaching a leash, the means for attaching a leash affixed to the longitudinal spine member near where the longitudinal spine member is affixed to the a means for containing the chest of the animal.

15. An animal coat with integrated harness comprising:
a cloth coat section for covering at least a front body section of an animal;
two leg openings in a bottom surface of the cloth coat section for accepting the animal's front legs;
a longitudinal spine member affixed to an inside upper location of the cloth coat section;
a neck encircling strap affixed to the longitudinal spine member at a location near a front portion of the longitudinal spine member;
a chest encircling strap affixed to the longitudinal spine member at a location rearward of the two leg openings;
a neck fastener affixed at ends of the neck encircling strap;
a chest fastener affixed at ends of the chest encircling strap; and
a leash attachment ring affixed to the longitudinal spine member near where the longitudinal spine member is affixed to the chest encircling strap.

16. The animal coat with integrated harness of claim 15, wherein the neck fastener and the chest fastener are snap fasteners.

17. The animal coat with integrated harness of claim 15, wherein the longitudinal spine member is affixed to the cloth coat section by stitching.

18. The animal coat with integrated harness of claim 15, wherein the neck encircling strap is affixed to the longitudinal spine member by stitching.

19. The animal coat with integrated harness of claim 15, wherein the chest encircling strap is affixed to the longitudinal spine member by stitching.
